(19) United States
(12) Patent Application Publication
(10) Pub. No.: US 2011/0200733 A1
(43) Pub. Date: Aug. 18, 2011

(54) FRUIT COMPOSITIONS WITH SOLUBLE DIETARY FIBER

(75) Inventor: Yuval Ashkenazi, Oakland, NJ (US)

(73) Assignee: B&G FOODS, INC., Parsippany, NJ (US)

(21) Appl. No.: 12/708,078

(22) Filed: Feb. 18, 2010

(51) Int. Cl. A23L 1/06; A23L 1/09; A23L 1/0522; A23L 1/0524; A23L 1/068; A23L 1/0562; A23L 1/0532; A23L 1/053; A23L 1/064

(52) U.S. Cl. 426/575; 426/578; 426/577; 426/576

(57) ABSTRACT

Fruit compositions and methods for providing a serving of food having at least 3 grams of dietary fiber to a human without altering the flavor, appearance or consistency of the food are provided. In a general embodiment, the present disclosure provides a fruit composition comprising a fruit component, a sweetener component and a soluble dietary fiber component, wherein the soluble dietary fiber component provides at least 3 grams of dietary fiber per serving of the fruit composition.

### BACKGROUND

The present disclosure relates generally to fruit compositions. More specifically, the present disclosure relates to fruit compositions comprising soluble dietary fiber.

Dietary fiber divides into two categories, soluble and insoluble dietary fiber. Both types are undigested and are not absorbed into the bloodstream. However, insoluble dietary fibers pass through intestines largely intact. Therefore, insoluble fiber functions to move bulk through the intestines while also controlling and balancing the pH in the intestines. Benefits of insoluble fiber include promoting regular bowel movement and preventing constipation, removing toxic waste through the colon in less time and helping prevent colon cancer by keeping an optimal pH in intestines to prevent microbes from producing cancerous substances.

On the other hand, soluble fiber changes as it passes through the digestive tract for absorbing water to become a gelatinous substance that passes through the digestive tract. By turning into a gel, soluble fiber traps carbohydrates and slows the absorption of glucose, thus reducing sugar response after eating. Moreover, soluble fiber is fermented by bacteria in the colon, thereby balancing intestinal pH, and binds bile acids in the small intestine, making them less likely to enter the body. Soluble fiber also prolongs stomach emptying time so that sugar is released and absorbed more slowly. Other benefits of soluble fiber include lowering total cholesterol and LDL cholesterol to therefore reduce the risk of heart disease, and regulating blood sugar for people with diabetes.

There are numerous types of fruit compositions available. Such compositions can include, for instance, standard preserves and jellies that are sweetened with sugar, corn syrup, high fructose corn syrup, and a combination of any of these sweeteners. Compositions also include spreadable fruits sweetened with fruit juice concentrates or sugar. Sugar-free compositions area also available, such as those compositions sweetened with sucralose.

It is generally known that while all these types of compositions exhibit differences meriting their respective names, these products traditionally are manufactured using sweeteners, fruits, natural flavors, pectins and acidifiers. However, whether it is one of the compositions discussed above or any other similar fruit composition, all fruit compositions provide a source of carbohydrates but fail to provide a significant amount of soluble dietary fiber. This is due, at least in part, to the failure to provide a soluble dietary source in a fruit composition in a sufficient amount to be considered a significant amount of soluble dietary fiber without affecting the appearance, texture and/or taste of the fruit composition.

### SUMMARY OF THE INVENTION

The present disclosure is directed to fruit compositions and methods for providing a serving of food having at least 3 grams of dietary fiber to a human without altering the flavor, appearance or consistency of the food. In a general embodiment, the present disclosure provides a fruit composition. The fruit composition comprises a fruit component, a sweetener component and a soluble dietary fiber component. The soluble dietary fiber component provides at least 3 grams of dietary fiber per serving of the fruit composition. In an embodiment, the serving size is 20 grams or less.

In an embodiment, the soluble dietary fiber component is, for example, an at least digestion-resistant dextrin, pectin, β-glucan, fructan, oligosaccharide, psyllium or combinations thereof. In an embodiment, the soluble dietary fiber component is the at least digestion-resistant dextrin. In an embodiment, the at least digestion-resistant dextrin is a digestion-resistant maltodextrin.

In an embodiment, the fruit composition is, for example, fruit jelly, fruit jam, fruit preserve, fruit marmalade, fruit spread and spreadable fruit.

In an embodiment, the fruit component is, for example, fruit, fruit juice, fruit concentrate or combinations thereof.

In an embodiment, the sweetener component is, for example, sugar, sugar substitutes, sugar alcohols, fruit juice, fruit concentrate and combinations thereof. In an alternative embodiment, the fruit composition contains no sugar.

In an embodiment, the fruit composition also includes a gelling agent such as, for example, pectin, gum, alginate, starch, agar, gelatin, carrageenan or combinations thereof.

In an embodiment, the soluble fiber component includes at least 90% fiber on a dry basis.

In another embodiment, the present disclosure provides a fruit composition comprising a fruit component, a sweetener component, and a digestion-resistant maltodextrin.

In yet another embodiment, the present disclosure provides a method for providing a serving of food having at least 3 grams of dietary fiber to a human. The method comprises administering to a human a fruit composition comprising a fruit component and a soluble dietary fiber component, wherein the soluble dietary fiber component is present in the fruit composition in an amount sufficient to provide at least 3 grams of dietary fiber per serving of the fruit composition to the human without altering the flavor, appearance or consistency of the food.

In a further embodiment, the present disclosure provides another method for providing a serving of food having a good source of dietary fiber to a human. The method comprises administering to a human 20 or less grams of a fruit composition comprising a fruit component and a soluble dietary fiber component, wherein the soluble dietary fiber component is present in the fruit composition in an amount sufficient to provide at least 3 grams of dietary fiber to the human without altering the flavor, appearance or consistency of the food.

An advantage of the present disclosure is to provide an improved fruit composition.

Another advantage of the present disclosure is to provide a fruit composition with a good source of soluble dietary fiber.

A further advantage of the present disclosure is to provide a fruit jelly, fruit jam, fruit preserve, fruit marmalade, fruit spread or spreadable fruit including a good source of soluble dietary fiber that does not alter the flavor, appearance or consistency of the fruit jelly, fruit jam, fruit preserve, fruit marmalade, fruit spread or spreadable fruit.

Yet another advantage of the present disclosure is to provide an improved method for providing a serving of fruit composition having a good source of dietary fiber to a human without altering the flavor, appearance or consistency of the fruit composition.

Additional features and advantages are described herein, and will be apparent from, the following Detailed Description.

### DETAILED DESCRIPTION

The present disclosure relates generally to fruit compositions with dietary fiber. More specifically, the present disclosure relates to fruit compositions comprising a fruit component and a soluble dietary component. Soluble dietary components such as indigestible or digestion-resistant dextrins, for example, are compatible with fruit compositions because they are water soluble, colorless, tasteless and odorless. As a result, indigestible or digestion-resistant dextrins such as, for example, resistant maltodextrin, do not add any flavor of their own nor do they directly influence flavors added to or naturally occurring in the foods to which they are added. Moreover, indigestible or digestion-resistant dextrins, such as resistant maltodextrin, are inherently stable to high-heat and high-acid process conditions.

Therefore, indigestible or digestion-resistant dextrins advantageously provide the opportunity to produce fruit compositions that achieve significant fiber fortification levels compatible with certain nutrient content claims without sacrificing the appearance, texture or flavor of the fruit composition. For example, to make a nutrient dietary fiber content claim such as “a good source of dietary fiber” (i.e. 10% or more of the recommended Daily Value), 2.5 grams must be present per finished serving of the finished food product. Accordingly, the present disclosure provides a fruit composition comprising a fruit component and a soluble dietary fiber component.

In an embodiment, the present disclosure provides a fruit composition comprising a fruit component, a sweetener component and a soluble dietary fiber component, the soluble dietary fiber component providing at least 3 grams of dietary fiber per serving of the fruit composition. In another embodiment, the serving can be 20 grams or less.

The soluble dietary fiber component can include, for example, an at least digestion-resistant dextrin, pectin, β-glucan, fructan, oligosaccharide, psyllium or combinations thereof. In an embodiment, the soluble dietary fiber component is the at least digestion-resistant dextrin. Examples of the at least digestion-resistant dextrin include Nutriose®, which is manufactured by Roquette. Digestion-resistant dextrins such as Nutriose® can include at least 85% fiber on a dry basis.

In another embodiment, the at least digestion-resistant dextrin can be a digestion-resistant maltodextrin. Examples of digestion-resistant maltodextrins include Fibersol®-2, which is manufactured by ADM/Matsutani LLC. Digestion-resistant maltodextrins such as Fibersol®-2 can include at least 90% fiber on a dry basis.

In an embodiment, the fruit component can be, for example, a fruit, a fruit juice, a fruit concentrate, a fruit blend or a combination thereof. In another embodiment, the fruit composition may include more than one fruit component such as, for example, more than one fruit type. The fruit juice can include a blend of juices from more than one fruit. Similarly, the fruit concentrate can include a blend of concentrates from more than one fruit. Non-limiting examples of the type or flavor of fruit, fruit juice or fruit concentrate include banana, citrus, lemon, orange, grape, lime, grapefruit, apple, pear, peach, strawberry, raspberry, blueberry, cherry, plum, pineapple, apricot, combinations thereof, and so forth.

The sweetener can be a non-fruit sweetener such as, for example, sugar, sugar substitutes, sugar alcohols, or combinations thereof. The sugar substitute may be, for example, polydextrose, stevia, brazzein, curculin, glycyrrhizin, glycerol, hydrogenated starch hydrolysate (HSH), inulin, isomalt, lactitol, luo han guo, mabinlin, miraculin, monatin, monellin, pentadin, tagatose, thaumatin or combinations thereof.

The sugar alcohol can include, for example, sorbitol, erythritol, xylitol, mannitol, maltitol or combinations thereof. Usage levels of sugar substitutes and sugar alcohols can vary greatly and will depend on such factors as potency of the sweetener, rate of release, desired sweetness of the fruit composition, level and type of flavor used in the fruit composition, other sugar alcohols and/or sugar substitutes in the fruit composition, the level of any other sugar alcohols and/or sugar substitutes in the fruit composition, and cost considerations.

The sweetener can be a fruit sweetener such as, for example, fruit juice, fruit concentrate or combinations thereof. Non-limiting examples of the type or flavor of fruit juice or fruit concentrate sweetener components include banana, citrus, lemon, orange, grape, lime, grapefruit, apple, pear, peach, strawberry, raspberry, blueberry, cherry, plum, pineapple, apricot, combinations thereof, and so forth.

Alternatively, the fruit composition can be sugar-free. The fruit composition may also be composed such that only fruit sweeteners contribute any and all sweetening effects to the fruit composition.

In an embodiment, the fruit composition can be, for example, a fruit jelly, a fruit jam, a fruit preserve, a fruit marmalade, a fruit spread or a spreadable fruit. As used herein, a “fruit jelly” is a fruit composition including a fruit juice and having a soluble-solids content not less than 65%. As used herein, a “fruit jam” or “fruit preserve” is a fruit composition including fresh, concentrated, frozen and/or canned fruits and having a soluble-solids content not less than 65%. As used herein, a “fruit marmalade” is a fruit composition including fruit juice and fruit peel. As used herein, a “spreadable fruit” is a fruit composition wherein the fruit component is the sweetener in the fruit composition. As used herein, a “fruit spread” is a fruit composition that is not a fruit jelly, a fruit jam, a fruit preserve, fruit marmalade or spreadable fruit.

In an embodiment, the fruit composition can further include a gelling agent. The gelling agent can include, for example, pectin, gum, alginate, starch, agar, gelatin, carrageenan and combinations thereof. Usage levels of the gelling agent can vary and will depend on factors such as the desired texture of the fruit composition, the desired appearance of the fruit composition, the type of fruit composition, other gelling agents used in the fruit composition, and the level of the other gelling agents in the fruit composition.

In an embodiment, the fruit composition can further include a food acid. The food acid can include, for example, citric acid, tartaric acid, malic acid, fumaric acid, lactic acid, vinegar or combinations thereof. The food acid serves multiple purposes including, for example, regulating pH levels to foods, adding acidic flavor notes to foods, adding “sharper” flavor notes to foods, providing antioxidants to foods, and preserving foods to extend shelf-life.

It should be appreciated that the fruit composition can provide one or more additional ingredients such as additional flavors, sensates, colors and sugar-free sweeteners (e.g. high intensity sweeteners). The ingredients can be added in a free form in any suitable amount.

It should also be appreciated that the fruit composition can provide one or more additional functional ingredients such as, for example, vitamins and minerals. Non-limiting examples of vitamins may include Vitamins A, B-complex (such as B-1, B-2, B-6 and B-12), C, D, E and K, niacin and acid vitamins such as pantothenic acid and folic acid, biotin and combinations thereof. Non-limiting examples of minerals may include calcium, iron, zinc, magnesium, iodine, copper, phosphorus, manganese, potassium, chromium, molybdenum, selenium, nickel, tin, silicon, vanadium, boron and combinations thereof.

In another embodiment, the present disclosure provides a method for providing a serving of food having at least 3 grams of dietary fiber to a human. The method comprises administering to a human a fruit composition comprising a fruit component and a soluble dietary fiber component. The soluble dietary fiber component is present in the fruit composition in an amount sufficient to provide at least 3 grams of dietary fiber per serving of the fruit composition to the human without altering the flavor, appearance or consistency of the food.

In a further embodiment, the present disclosure provides a method for providing a serving of food having a good source of dietary fiber to a human. The method comprises administering 20 or less grams of a fruit composition to a human. The fruit composition comprises a fruit component and a soluble dietary fiber component. The soluble dietary fiber component is present in the fruit composition in an amount sufficient to provide at least 3 grams of dietary fiber to the human without altering the flavor, appearance or consistency of the food.

### EXAMPLES

By way of example and not limitation, the following examples are illustrative of various embodiments of the present disclosure.

### Example 1

### Spreadable Raspberry Fruit Spread

| Ingredient | Percentage |
|---|---|
| Raspberry solids | 52.63% |
| Fibersol-2 (90% fiber) | 18.09% |
| Sugar | 29.61% |
| Water | 14.93% |
| Pectin | 0.69% |
| Citric acid | 0.36% |
| Evaporation | −17.70% |
| Percent Input | 117.70% |
| Percent Yield | 100.00% |

For a serving size of 18 grams, which is approximately equivalent to one tablespoon of fruit spread, Example 1 provides 3 grams of dietary fiber. Example 1 also has a Brix value of 54, a total acid of between 0.9 and 1.15, and a pH of between 3.25 and 3.35.

### Example 2

### All Fruit Seedless Strawberry Jam—No Sugar Added

| Ingredient | Percentage |
|---|---|
| Seedless Strawberry puree | 20.75% |
| Fibersol-2 (90% fiber) | 16.86% |
| Water | 27.06% |
| White Grape Juice | 14.92% |
| Pear concentrate | 35.63% |
| Pectin | 1.08% |
| Strawberry Flavor | 0.20% |
| Citric Acid | 1.66% |
| Calcium Chloride | 0.03% |
| Evaporation | −18.21% |
| Pounds Input | 118.21% |
| Pounds Yield | 100.00% |

For a serving size of 18 grams, which is approximately equivalent to one tablespoon of fruit spread, Example 2 provides 3 grams of dietary fiber. Example 1 also has a Brix value of 53, a total acid of between 0.8 and 0.9, and a pH of between 3.28 and 3.32.

### Example 3

### Sugar Free Strawberry Preserve

| Ingredient | Percentage |
|---|---|
| Strawberry solids | 31.69% |
| Polydextrose | 7.26% |
| Fibersol-2 (90% fiber) | 17.16% |
| Pectin | 1.27% |
| Locust Bean Gum | 0.46% |
| Strawberry Flavor | 0.35% |
| Sucralose | 0.15% |
| Potassium Sorbate | 0.05% |
| Sodium Benzoate | 0.05% |
| Red #40 Color | 0.01% |
| Citric Acid | 1.39% |
| Calcium Chloride | 0.03% |
| Potassium Citrate | 0.10% |
| Water | 46.39% |
| Evaporation | −6.36% |
| Total Input | 106.36% |
| Total Yield | 100.00% |

For a serving size of 17 grams, which is approximately equivalent to one tablespoon of fruit spread, Example 2 provides 3 grams of dietary fiber.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fruit composition comprising:
a fruit component;
a sweetener component and
a soluble dietary fiber component, wherein the soluble dietary fiber component provides at least 3 grams of dietary fiber per serving of the fruit composition.

2. The fruit composition of claim 1, wherein the soluble dietary fiber component is selected from the group consisting of an at least digestion-resistant dextrin, pectin, β-glucan, fructan, oligosaccharide, psyllium and combinations thereof.

3. The fruit composition of claim 2, wherein the soluble dietary fiber component is the at least digestion-resistant dextrin.

4. The fruit composition of claim 3, wherein the at least digestion-resistant dextrin is a digestion-resistant maltodextrin.

5. The fruit composition of claim 1, wherein the serving size is 20 grams or less.

6. The fruit composition of claim 1, wherein the fruit composition is selected from the group consisting of fruit jelly, fruit jam, fruit preserve, fruit marmalade, fruit spread and spreadable fruit.

7. The fruit composition of claim 1, wherein the fruit component is selected from the group consisting of fruit, fruit juice, fruit concentrate and combinations thereof.

8. The fruit composition of claim 1, wherein the fruit composition contains no sugar.

9. The fruit composition of claim 1, wherein the sweetener component is selected from the group consisting of sugar, sugar substitutes, sugar alcohols, fruit juice, fruit concentrate and combinations thereof.

10. The fruit composition of claim 1, further comprising a gelling agent selected from the group consisting of pectin, gum, alginate, starch, agar, gelatin, carrageenan and combinations thereof.

11. The fruit composition of claim 1, wherein the soluble fiber component comprises at least 90% fiber on a dry basis.

12. A fruit composition comprising:
a fruit component;
a sweetener component, and
a digestion-resistant maltodextrin.

13. A method for providing a serving of food having at least 3 grams of dietary fiber to a human, the method comprising:
administering to a human a fruit composition comprising a fruit component and a soluble dietary fiber component, wherein the soluble dietary fiber component is present in the fruit composition in an amount sufficient to provide at least 3 grams of dietary fiber per serving of the fruit composition to the human without altering the flavor, appearance or consistency of the food.

14. The method of claim 13, wherein the soluble dietary fiber component is selected from the group consisting of an at least digestion-resistant dextrin, pectin, β-glucan, fructan, oligosaccharide, psyllium and combinations thereof.

15. The method of claim 14, wherein the at least digestion-resistant dextrin is a digestion-resistant maltodextrin.

16. The method of claim 13, wherein the fruit composition is selected from the group consisting of fruit jelly, fruit jam, fruit preserve, fruit marmalade, fruit spread and spreadable fruit.

17. The method of claim 13, wherein the serving size is 20 grams or less.

18. The method of claim 13, wherein the fruit component is selected from the group consisting of fruit, fruit juice, fruit concentrate and combinations thereof.

19. The method of claim 13, wherein the soluble fiber component comprises at least 90% fiber on a dry basis.

20. A method for providing a serving of food having a good source of dietary fiber to a human, the method comprising:
administering to a human 20 or less grams of a fruit composition comprising a fruit component and a soluble dietary fiber component, wherein the soluble dietary fiber component is present in the fruit composition in an amount sufficient to provide at least 3 grams of dietary fiber to the human without altering the flavor, appearance or consistency of the food.
